(19) United States
(12) Patent Application Publication
(10) Pub. No.: US 2014/0220228 A1
(43) Pub. Date: Aug. 7, 2014

(54) EXTRACTION OF PHYTOCHEMICALS AND IMPROVED ANIMAL FEED

(71) Applicant: Cellulose Sciences International, Inc., Verona, WI (US)

(72) Inventor: Rajai H. Atalla, Verona, WI (US)

(73) Assignee: Cellulose Sciences International, Inc., Verona, WI (US)

(21) Appl. No.: 14/143,817

(22) Filed: Dec. 30, 2013

Related U.S. Application Data
(63) Continuation-in-part of application No. 12/935,447, filed on Dec. 28, 2010, now Pat. No. 8,617,851.
(60) Provisional application No. 61/042,133, filed on Apr. 3, 2008.
(60) Provisional application No. 61/790,431, filed on Mar. 15, 2013.

(51) Int. Cl. A23K 1/14

(52) U.S. Cl. CPC A23K 1/146
USPC 426/635; 426/429

(57) ABSTRACT

Disclosed are methods and systems for a first stage of fractionating a lignocellulosic material or lignocellulosic-containing biomass to extract phytochemicals and low molecular weight lignins and lignans, collectively identified as extractives, by treating lignocellulosic material or biomass with an alkali in an exemplary alcohol/water co-solvent system. The extractives are species specific and can later be separated and isolated individually. The system has the added advantage that it renders the residual polymeric biomass, sometimes referred to as bagasse, as an enhanced digestibility animal feed or more accessible for enzymatic or chemical modification. The extractives separated in the methods of the invention are in a form closer to their native state than any form that can be obtained from other biomass pretreatment processes.

### CROSS-REFERENCE TO RELATED APPLICATIONS

This application is a continuation-in-part of U.S. patent application Ser. No. 12/935,447, filed Dec. 28, 2010, now U.S. Pat. No. 8,617,851, which is a national stage filing under 35 U.S.C. 371 of International Application No. PCT/US2009/039445, filed Apr. 3, 2009, which claims priority to U.S. Provisional Patent Application No. 61/042,133, filed Apr. 3, 2008, and claims priority to U.S. Provisional Patent Application No. 61/790,431, filed Mar. 15, 2013. These applications are incorporated herein by reference in their entirety.

### STATEMENT REGARDING FEDERALLY SPONSORED RESEARCH OR DEVELOPMENT

Not Applicable.

### INTRODUCTION

Biomass or lignocellulosic residues, such as agricultural wastes (e.g., corn stover, corn cobs, wheat straw), grasses (e.g., switchgrass, sawgrass), as well as forestry wastes (e.g, wood chips, sawdust), provide a potentially large renewable feedstock for the production of fuels, chemicals, plastics and feeds. The attractiveness of such production from biomass emanates from the wide availability and renewability of these feedstocks. In the current environment, it is also clear that such production reduces the dependence on fossil fuels and allows avoidance of burning or land-filling lignocellulosic waste materials.

With the recent emphasis on the uses of renewable materials, processes have been sought that allow derivation of greater value from the constituents of biomass than simply the energy value accessible through combustion or the production of pulp from select types of biomass. Major efforts have been devoted to recovery of the polysaccharides and their saccharification while using the residual lignins as fuel. More limited efforts have focused on conversion or modification of agricultural residues for utilization as feeds for ruminant animals.

Biomass or lignocelluloses are composed generally of three main components, namely, cellulose, hemicelluloses and lignin in varying quantities and forms. Cellulose and hemicellulose are polymers of simple sugars that can be converted into monosaccharides, which can in turn be converted to alcohols, such as ethanol or butanol, by fermentation or microbiological processes or they can be used for production of other chemicals, e.g., hydrocarbons, by chemical catalysis. Derivatives of cellulose are also of commercial importance and include rayon, cellophane, thickeners used in foods and paints, and coatings.

Lignin is a dendritic network polymer of phenylpropanoid units which can be converted into plastics, adhesives and resins. Lignin, however, can inhibit the hydrolysis of cellulose, and many approaches for attaining high yield conversion of cellulose seek to disrupt the lignin seal in lignocellulosic materials.

In addition, there is a wide variety of phytochemicals together with low molecular weight saccharides and proteins. The phytochemicals, commonly called extractives, represent minor fractions of the biomass depending on species. Phytochemicals are often biologically active as they form a substantial part of the defense of the source plant against pathogens and predators. In grasses, phytochemicals function to inhibit the action of enzymes that deconstruct polysaccharides, whether the enzymes are produced by biomass-degrading fungi or by microorganisms within the digestive tracts of ruminant animals.

In pulping of woody biomass, some of the phytochemicals may separate into a non-aqueous phase, usually referred to as tall oil, and can be fractionated through complex distillation processes. Others remain in solution in the black liquor and are burned for their energy value together with the degraded lignin and the degradation products of much of the hemicelluloses.

In a limited number of contexts, particular phytochemicals can be extracted by mechanical action as, for example, in the instance of sugarcane for the extraction of sucrose or in the instance of the rubber tree or the guayule shrub for the extraction of rubber. In such instances, the residue after the extraction of the chemical of interest is classified as bagasse and regarded as an agricultural residue of little value except for the production of lignocellulosic fibers or pelletization for use as fuel in boilers. In such situations, the value of other phytochemicals is usually not realized because of the complex extraction processes involved in their isolation.

On the other hand, when phytochemicals have been found to have medicinal value, special procedures have been used for extracting them. Such procedures are usually very expensive and economically justified only on the basis of the pharmaceutical value. Apart from application in this context, phytochemicals have received very little attention in the fractionation of biomass because of their diversity, complexity and difficulty in isolating them.

Specifically, phytochemicals typically are not soluble in water under ambient conditions due to their organic nature and the preponderance of non-ionic bonds in their architectures. However, they are readily soluble in various organic solvents such as aliphatic alcohols, hexanes, dioxanes, acids, ethers, methylene chloride, trichloroethylene, acetonitrile and the like. Numerous methods are known for extracting phytochemicals from plant materials, most based on sequential extraction processes incorporating one or more organic solvents in combination with washing steps. The types and concentrations of organic solvents must be carefully selected in order to avoid structural changes to the target phytochemicals during extraction that may adversely affect one or more of their desirable physical, chemical and biological properties.

For example, in traditional methods of wood chemistry, the phytochemicals have been extracted using a constant boiling mixture of ethanol and benzene (1). However, since the carcinogenic character of benzene was recognized, ethanol and either toluene or dichloroethane have been used instead most often. Other mixtures of polar and nonpolar organic solvents have also been used. For example, in more recent studies of the extraction of phytochemicals from guayule, a mixture of acetone and hexane has been used (2, 3).

One of the disadvantages of these traditional methods for extraction of phytochemicals from biomass using organic solvents for extraction is that organic solvents do not penetrate well into plant cell walls because of the hydrophilic environment created by the dominance of polysaccharides among the constituents of most plant cell walls. For this reason, it is common to ball mill biomass prior to extraction of phytochemicals. Ball milling, however, is very energy intensive so that it is not likely to be viable in commercial processes for isolation of phytochemicals that cannot command a high premium. Furthermore, the mechanochemistry associated with severe mechanical action on biomass can alter and degrade the character of the phytochemicals.

In addition to extracting value from biomass via phytochemical extraction, efforts have been made to enhance the feed value of agricultural residues such as corn stover and wheat straw. Application of aqueous alkaline treatments has been used with varying degrees of enhancement. These have included the use of ammonia, calcium hydroxide, sodium hydroxide or mixtures of the latter two, always applied within the context of an aqueous liquid system.

### BRIEF DESCRIPTION

Embodiments described herein provide a process for extracting phytochemicals from plant-derived biomass and yielding an enhanced digestibility animal feed. The process includes a multicomponent system that can penetrate and expand cell wall polysaccharides and simultaneously solvate the organic phytochemicals. The system includes an aqueous alkali system of sufficient concentration to penetrate the polysaccharides in combination with a polar, water-miscible solvent which has the capacity to extract at least a portion of the phytochemicals and simultaneously breaking many linkages of lignin to the polysaccharides. The process yields a liquid extract or fraction and a solid residue or fraction. The liquid fraction is suitably separated from the solid fraction, and the phytochemicals can be recovered from the liquid fraction. The system is optimally effective at ambient temperature and pressure to avoid denaturation or degradation of the phytochemicals and to preserve the nutritional value of agricultural residues so treated.

Among the extractives or phytochemicals soluble in the multicomponent treatment system in accordance with the present invention are ferulic acid and ferulic acid derivatives, such as ferulic acid esters. Most of the remaining biomass residue will consist of cellulose, hemicelluloses and lignin, all predominantly polymeric in nature. The solid fraction is suitably provided as a high value animal feed. In agricultural residues, high molecular weight proteins and other nutritional components may also remain in the solid fraction to be used as feed.

In another aspect, a method of solubilizing a significant portion of the extractives in a lignocellulosic biomass is provided. The method includes treating a lignocellulose-containing biomass with an alkali in a co-solvent to yield a treated biomass, and separating a liquid fraction of extractives from the treated biomass.

Also provided is a method of enhancing digestibility of agricultural/forest residues. The method includes removing a portion of the phytochemicals, delignifying at least a portion of the lignin, and disrupting the nanoscale molecular/crystal structure of the cellulose by contacting the residue with an alkaline cosolvent treatment to yield an animal feed with enhanced digestibility. The alkaline cosolvent is suitably an alkaline aqueous aliphatic alcohol. The nanoscale disruption of the molecular structure of the cellulose represents a decrease in the average crystallinity of the cellulose.

In another aspect, a method of extraction is provided including contacting a biomass, agricultural residue or forestry waste with an aqueous alkaline alcoholic solution to extract at least a portion of the phytochemicals and the lignin from the biomass or agricultural residue or forestry waste.

A further method is provided including removing at least a portion of ferulic acid and ferulic acid derivatives from the cell walls of a plant-derived biomass in an amount effective to enhance the digestibility of the biomass.

Also provided is a method of modifying a biomass feed, including treating a biomass feed with an alkaline water-miscible solvent solution to yield a liquid fraction and a solid fraction, separating and optionally drying the solid fraction to yield a modified biomass feed with improved digestibility.

In a further aspect, a method of removing ferulic acid and ferulic acid derivatives from a biomass is provided, including treating the biomass with an alkaline water-miscible solution to form a liquid fraction, and separating and recovering the ferulic acid and ferulic acid derivatives.

A further method includes reducing inhibition of a plant material to cellulases, i.e., cellulose hydrolysis, by extracting the plant material with an aqueous alkaline alcoholic

In yet another embodiment, a method is provided for reducing inhibition of glycosidase hydrolysis of lignocellulosic material by the different constituents of the extractives. The method includes contacting the lignocellulosic material with an alkali in a co-solvent system to at least partially delignify the lignocellulosic material, and separating a liquid fraction containing a lignin composition. The product is then provided as a high value feed for ruminant livestock or as a cellulosic source for a saccharification reaction.

The methods and systems herein also include treating lignocellulosic feedstocks with a solution of an alkali in a co-solvent system, including water and a second solvent that is polar and fully water-miscible, to form a deaggregated cellulose, and washing out the alkali from the deaggregated cellulose to stabilize the deaggregated cellulose in an aqueous medium. The washing may be accomplished with a co-solvent system that is the same as in the treating step with the varying ratios of water and second solvent, and finally, with water itself. Among the most effective co-solvents are suitably alcohols.

In yet another aspect, the principles of the processes described herein are manifest in a method of enhancing the susceptibility of a lignocellulose-containing biomass to hydrolysis, which includes treating a lignocellulose-containing biomass with an alkali in a co-solvent to yield a pretreated biomass. The pretreated biomass is then provided as a substrate for a hydrolysis or depolymerization reactions, whether as a prelude to fermentation or as a feed for livestock.

In an illustrated embodiment, a method of simultaneously extracting the phytochemicals and deaggregating a lignocellulosic material or biomass is provided. The method includes treating a biomass with a concentrated alkali in a co-solvent system to extract the phytochemicals from the lignocellulosic material to form a treated biomass and a liquid fraction, separating the liquid fraction which contains phytochemicals and low molecular weight lignins or lignans (hereinafter referred to collectively as “extractives”), and washing the treated biomass with co-solvent and then further with water.

In further aspect, a process for the treatment for lignocellulosic material or biomass, e.g., grassy herbaceous biomass, woody biomass, or agricultural residues such as bagasse, is provided under mild conditions that opens up the tightly aggregated polysaccharides in the plant cell walls, while simultaneously extracting the nonpolymeric phytochemicals. The method both extracts the phytochemicals and enhances accessibility of cell wall polysaccharides to cell wall hydrolases. As such, the process is economically viable, and it is believed to be an important step toward advancing national goals for lignocellulosic biofuels and biobased chemicals. It also provides a basis for converting low value agricultural residues into high value feeds for ruminant livestock. Thus, an animal feed is provided that is produced from the methods described herein.

All methods may be conducted at mild conditions of temperature and pressure, e.g., ambient temperature and pressure. The biomass may suitably be in particulate form.

A lignin composition is also provided that is produced from the methods in accordance with principles described herein. Because of the mild conditions of isolation, it is believed that the lignin is in a relatively natural unprocessed, undegraded state.

According to the principles manifest in embodiments described herein, methods and systems are provided which extract at least a portion of phytochemical and delignify a lignocellulosic material as well as provide nanoscale disruption of the molecular/crystal structure of cellulose therein so that the cellulose is more accessible for enzymatic or chemical modification, e.g., depolymerization or hydrolysis reactions. The methods and systems, in effect, simultaneously enhance the conversion of cellulose-based feedstocks for use in production of nutrients, biofuels, biobased chemicals and cellulose derivatives as well as simplify the recovery of phytochemicals.

### BRIEF DESCRIPTION OF THE DRAWINGS

Embodiments described herein may be better understood and appreciated by reference to the detailed description presented herein in conjunction with the accompanying drawings of which:

FIG. 1 is a flowchart illustrating a system in accordance with embodiments described herein including the treatment of a biomass feedstock to partially delignify, extract phytochemicals and increase the treated biomass accessibility to depolymerization;

FIG. 2 is a flowchart illustrating a system in accordance with embodiments described herein including the treatment of cellulosic feedstock to increase its accessibility to depolymerization;

FIG. 3 is an x-ray diffractogram of a pulp before and after the treatment process in accordance with embodiments described herein;

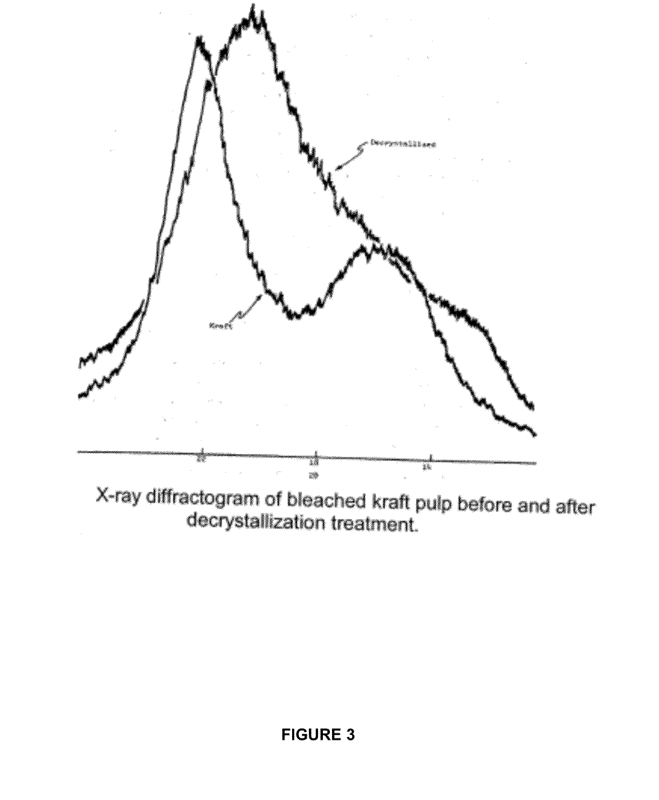

FIG. 4 is an x-ray diffractogram of corn stover before and after the treatment in accordance with embodiments described herein;

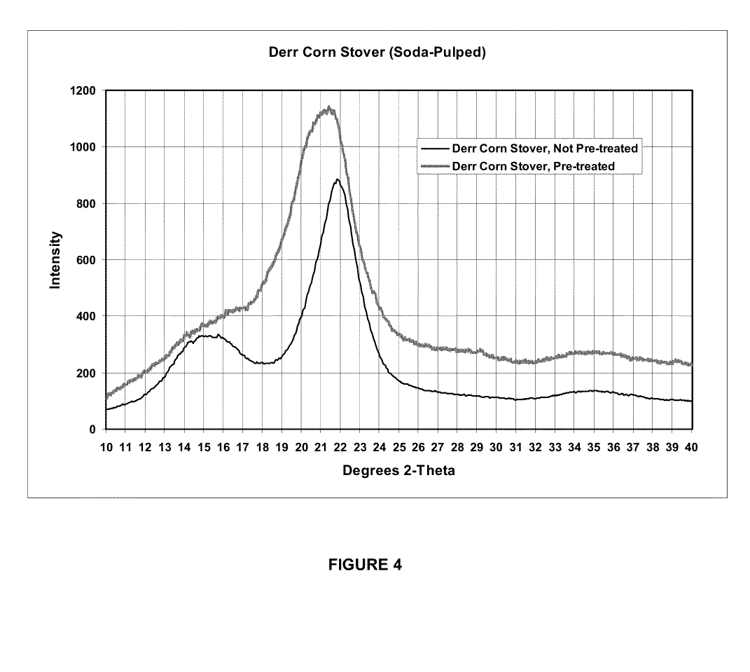

FIG. 5 depicts Raman spectra of corn stover before and after extraction of phytochemicals and low molecular weight lignins by the process described in an embodiment herein; and

FIG. 6. shows photographs of a bagasse sample before and after treatment by the process described in an embodiment herein.

### DETAILED DESCRIPTION

Methods and systems are provided in which a lignocellulosic material or lignocellulose-containing (i.e., plant-derived) biomass is at least partially extracted by treatments which include contacting the material or biomass with a concentrated alkali in a co-solvent system that includes water and a water-miscible solvent, e.g., an alcohol or polyol, under mild conditions. The treatment when applied to biomass, e.g., grassy herbaceous biomass, or bagasse, simultaneously extracts phytochemicals, partially delignifies and enhances accessibility of cell wall polysaccharides to cell wall hydrolases. In the methods described herein, cellulose is made more accessible for enzymatic and chemical reaction. For example, when applied to corn stover at room temperature and pressure, the method facilitates saccharification at levels equal to or greater than achieved through treatment with acid at elevated temperatures. The methods and systems described herein, thus, increase the efficiency of enzymatic or chemical modification of cellulose for use as biofuels, biobased chemicals or cellulose derivatives. Two factors enter into this enhancement. One is increased accessibility of the polysaccharide matrix to polysaccharide hydrolases. A more subtle factor not generally recognized is the removal of some of the phytochemicals that inhibit the action of the hydrolases. It is recognized that development of some of these phytochemicals is part of the adaptive response of plants to predation by herbivores. Removal of these phytochemicals simultaneously with partial disordering of cellulose molecular aggregation make cellulose and related polysaccharides more accessible to digestive microorganisms in intestinal tracts of ruminant animals.

Before any embodiments are explained in detail herein, however, it is to be understood that the embodiments are not limited in application to lignocellulosics and to the details of compositions and the arrangement of components set forth in the following description, illustrated in the following drawings or exemplified by the Examples. Such description, drawings, and Examples are not intended to limit the scope of the embodiments of the processes described herein as set forth in the appended claims. Other embodiments can be practiced or carried out in various other ways.

Further, no admission is made that any reference, including any patent or patent document, cited in this specification constitutes prior art. In particular, it will be understood that, unless otherwise stated, reference to any document herein does not constitute an admission that any of these documents form part of the common general knowledge in the prior art in the United States or in any other country. Any discussion of the references states what their authors assert, and the applicant reserves the right to challenge the accuracy and pertinence of any of the documents cited herein.

Throughout this disclosure, various aspects of the methods and systems described herein may be presented in a range format. It should be understood that the description in range format is merely for convenience and brevity, and should not be construed as an inflexible limitation on the scope of the processes described herein. Accordingly, as will be understood by one skilled in the art, for any and all purposes, particularly in terms of providing a written description, all ranges disclosed herein also encompass any and all possible subranges and combinations of subranges thereof, as well as all integral and fractional numerical values within that range. As only one example, a range of 20% to 40% can be broken down into ranges of 20% to 32.5% and 32.5% to 40%, 20% to 27.5% and 27.5% to 40%, etc. Any listed range is also easily recognized as sufficiently describing and enabling the same range being broken down into at least equal halves, thirds, quarters, fifths, tenths, etc. As a non-limiting example, each range discussed herein can be readily broken down into a lower third, middle third, and upper third, etc. Further, as will also be understood by one skilled in the art, all language such as “up to,” “at least,” “greater than,” “less than,” “more than” and the like include the number recited and refer to ranges which can be subsequently broken down into subranges as discussed above. In the same manner, all ratios disclosed herein also include all subratios falling within the broader ratio. Further, the phrases “ranging/ranges between” a first indicate number and a second indicate number and “ranging/ranges from” a first indicate number “to” a second indicate number are used herein interchangeably. The foregoing are only examples of what is specifically intended.

Also, it is to be understood that the phraseology and terminology used herein is for the purpose of description and should not be regarded as limiting. The use of “comprising,” “including,” “having,” and variations thereof herein is meant to encompass the items listed thereafter and equivalents thereof as well as additional items. “Comprising” encompasses the terms “consisting of” and “consisting essentially of.” The use of “consisting essentially of” means that the composition or method may include additional ingredients and/or steps, but only if the additional ingredients and/or steps do not materially alter the basic and novel characteristics of the claimed composition or method. Unless specified or limited otherwise, the terms such as “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

Unless otherwise noted, technical terms are used according to conventional usage. However, as used herein, the following definitions may be useful in aiding the skilled practitioner in understanding the embodiments described herein:

As used herein, the terms “lignocellulosic feedstock”, “lignocellulosic substrate”, “lignocellulosic material”, or “biomass” are meant to refer to any type of biomass that contains cellulose, hemicelluloses, lignin and phytochemicals. For example, lignocellulosic feedstocks may include grasses such as switch grass, cord grass, rye grass, miscanthus, or a combination thereof; sugar-processing residues such as sugar cane or guayule bagasse and sugar beet pulp; agricultural wastes such as soybean stover, corn stover; oat straw, rice straw, rice hulls, barley straw, corn cobs, wheat straw, canola straw, oat hulls, and corn fiber; and forestry wastes, such as recycled wood pulp fiber, sawdust, hardwood, softwood, or any combination thereof. Lignocelluloses feedstock may also include lignocellulosic waste or forestry waste materials such as newsprint, cardboard and the like. Lignocellulosic feedstock may also include one or more species of fiber that originate from different lignocellulosic feedstocks. Wheat straw, barley straw, corn stover, soybean stover, canola straw, switch grass, reed canary grass, sugar cane bagasse, guayule bagasse cord grass, oat hulls, sugar beet pulp and miscanthus are particularly advantageous as cellulosic feedstocks due to their widespread availability and low cost.

The term “hydrolytic enzyme(s)” is meant to refer to enzymes that catalyze hydrolysis of biological materials such as cellulose or the hemicelluloses and other cell wall polysaccharides. Hydrolytic enzymes include “cellulase enzymes” or “cellulases” (used interchangeably) which are enzymes that catalyze the hydrolysis of cellulose to products such as glucose, cellobiose, cello-oligodextrins, and other cello-oligosaccharides. “Cellulase” is meant to be a generic term denoting a multienzyme complex or family, including exo-cellobiohydrolases (CBH), endoglucanases (EG), and β-glucosidases (βG) that can be produced by a number of plants and microorganisms. It is also mean to include cellulosomes produced by digestive microorganism, which consist of multiple cellulases held together by a protein dockerin, so as to enhance their effectiveness. It is noted that many cellulase extracts also include some hemicellulases. Hemicellulases can also consist of a family of hydrolytic enzymes that act in a complementary manner to depolymerize hemicelluloses and other polysaccharides to their constituent monosaccharides in manners analogous to that described for the cellulases. Processes described herein may be carried out with any type of cellulase enzyme complex, or in concert with hemicellulose complexes, regardless of their source; however, microbial hydrolases are generally available at lower cost than those of plants. Among the most widely studied, characterized, and commercially produced hydrolases are, e.g., those obtained from fungi of the genera Aspergillus, Humicola, and Trichoderma, and from the bacteria of the genera Bacillus and Thermobifida. Also, for example, cellulase produced by the filamentous fungi Trichoderma longibrachiatum includes at least two cellobiohydrolase enzymes termed CBHI and CBHII and at least 4 EG enzymes.

“Fermentation microorganisms” refer to microorganisms that can catalyze the conversion of the plant cell wall sugars sugars to alcohols, including ethanol as well as higher chain alcohols such as butanol. Typically, yeast such as Saccharomyces cerevisiae is used to accomplish the conversion. Conversions may also include the use of microorganisms such as Clostridium acetobutylicum as well as microorganisms that are engineered to produce the higher chain alcohols from the sugars of cell wall polysaccharides.

As used herein, the terms “treatment,” “treating,” “pretreatment,” or “pretreating” in respect of biomass are meant to refer to a process or treatment described herein in which lignin is at least partially removed from the biomass together with phytochemicals and cellulose is made more accessible for enzymatic or chemical, e.g., chemical catalytic, reaction.

“Modification or degradation” in reference to cellulose is used to refer to the biological, e.g., enzymatic, or chemical-induced alteration of the native structure of cellulose. Such changes and alterations are known to those in the art and include those involved in enzymatic degradation and/or enzymatic or chemical hydrolysis of cellulose, as well as chemical modifications involved in a variety of commercial cellulose-based products, production of alcohols by fermentation of biomass, and generation of hydrogen-rich biofuels.

The term “stable” or “stabilizing” refers to a deaggregated cellulose that does not change materially over a selected period of time and under selected conditions.

In view of the disadvantages inherent in conventional lignocellulose fractionation, embodiments described herein provide novel methods for deaggregating lignocellulose or biomass while simultaneously extracting both phytochemicals and low molecular weight lignins where such occur. The methods include reacting a biomass with a treatment solution, which includes an alkali dissolved in a co-solvent system under mild conditions of temperature and pressure that may be optimized for economic feasibility. Subjecting the biomass to such treatment in accordance with embodiments described herein makes the cellulose therein more accessible for enzymatic or chemical reaction, by opening up, at the nano-scale, the tightly aggregated domains, which are also the source of recalcitrance during hydrolysis. Importantly, the methods provide a soluble liquid extract having phytochemicals therein. Certain components (e.g., lignin) can reduce the chemical and physical accessibility of the biomass, which can reduce the susceptibility to chemical and/or enzymatic conversion.

A system embodying the principles described herein was initially developed to produce nanoscale disrupted cellulose, a previously unknown form that differs from all known polymorphs, and that is much more accessible to enzymes than native celluloses. When applied to commercial microcrystalline cellulose derived from high purity dissolving pulps, which is frequently the standard in studies of saccharification, the treatment results in reduction of the incubation time necessary for saccharification or, alternatively, in reduction of the prerequisite dosage of enzymes by an order of magnitude.

The process embodying the principles described herein is a simple one. It requires that the lignocellulosic substrate be treated with a solution of alkali, e.g., sodium hydroxide (NaOH) or potassium hydroxide (KOH), in a co-solvent that is, e.g., 75% ethanol and 25% water or 3:1 ratio of alcohol to water. This is followed by removal of the alkali under conditions that avoid conversion to cellulose II, the mercerized form. The alkali co-solvent is suitably present in a ratio of about 4:1 to the weight of biomass (volume co-solvent:weight biomass).

As described above, the treatment solution includes an alkali dissolved in a co-solvent system. Suitably, the alkali is dissolved in a co-solvent system of water plus a second water-miscible solvent. In one aspect, the second solvent is suitably an alcohol which may include, e.g., methanol, ethanol, propanol, isopropanol, butanol, isobutanol, or a polyol. In another aspect, the second solvent may suitably include other protic solvents as well as aprotic solvents that are miscible in water. In an illustrated embodiment, the co-solvent system is ethanol and water.

In some embodiments, the alkali is suitably sodium hydroxide (NaOH) or potassium hydroxide (KOH), although other alkalis may be used, such as lithium hydroxide (LiOH). The concentration of, for example, NaOH or KOH needed in the treatment solution depends on the nature of the lignocellulosic material to be treated, as different lignocelluloses may have their polymeric forms disrupted at different concentrations of alkali. For example, the threshold for mercerization of most pulps is approximately 8% NaOH in water; for cotton, it is about 11% to 12%, depending on prior pretreatment; and for bacterial cellulose, it is about 14%. Thus, it has been found that a hydroxide concentration greater than 1 M, and suitably 1M-2.5 M is generally desirable.

It had been found that boiling of celluloses isolated at room temperature resulted in tight molecular aggregation in cellulose and a decline in accessibility to probe molecules. That work led the inventor to consider the possibility that absent the elevated temperature, lignin in corn stover might be sufficiently loosely bound that its constraint on action of hydrolases may be reduced. The method embodying the principles described herein was applied to biomass that had not been previously processed at elevated temperatures, e.g., a sample of corn stover that had been knife milled to 6 mm. The inventor then discovered that another process was unfolding as well, namely, the removal of phytochemicals and a significant fraction of lignin.

While some linkages are known to be quite labile in an alkaline environment, the hydrophobicity of lignins limits their solubility in aqueous media. The effectiveness of the system embodying the principles of the embodiments described herein includes a significant amount of ethanol, which is believed to be effective in solubilizing a majority of phytochemicals as well as low molecular weight lignins and lignans. It is noted that the use of ethanol to facilitate dissolution of lignin monomers has been used in laboratory studies of lignin chemistry.

Embodiments of the principles disclosed herein include a method of extracting phytochemicals from a biomass. The method includes contacting a biomass with a treatment solution to obtain a liquid fraction and a solid fraction, the treatment solution being an alkaline co-solvent, separating the liquid fraction from the solid fraction; and recovering at least one phytochemical from the liquid fraction, wherein the solid fraction is optionally dried and used as an animal feed. The extracted phytochemicals include ferulic acid and ferulic acid derivatives. The phytochemicals are generally of molecular weight of less than 1000.

In another embodiment, a simultaneous method of extracting phytochemicals and disrupting the molecular/crystal structure of a lignocellulosic biomass is provided. The method includes contacting a biomass with a treatment solution to form a slurry/dispersion, the treatment solution being an alkaline co-solvent, separating the slurry/dispersion into a liquid fraction and a solid fraction, separating the liquid fraction from the solid fraction, wherein the liquid fraction includes one or more phytochemicals and wherein the solid fraction is optionally dried and used as an animal feed suitable for ruminants. Yet another embodiment provides a process for preparing an enhanced digestibility feed from an agricultural residue. The process includes performing an extraction process on the residue using an alkaline co-solvent comprising water, alcohol and a base, filtering the solution to produce an extract solution and a treated residue, and collecting and optionally drying the treated residue to yield an enhanced digestibility animal feed.

The alkaline co-solvent is an alkaline or alkaline earth hydroxide in an aqueous aliphatic alcohol solution. The liquid fraction further includes at least a portion of the lignin in the biomass. The solid fraction is suitably further processed by washing the solid fraction with co-solvent, followed by water, and neutralizing the liquid in contact with the biomass to yield an at least partially deaggregated biomass.

As seen in the Examples, a method is provided for enhancing digestibility of agricultural/forestry residue. The method includes removing a portion of the phytochemicals from the residue and deaggregating the cellulosic structure of the residue by contacting the residue with an alkaline co-solvent treatment to yield an animal feed with enhanced digestibility compared to an untreated residue. Additionally, the method removes at least a portion of ferulic acid and ferulic acid derivatives from the cell walls of the residue in an amount effective to enhance the digestibility of the residue. Thus, there is provided an animal feed product which includes a plant material treated with an alkaline co-solvent solution to remove at least a portion of phytochemicals/extractives and a portion of lignin in the plant material.

In a further embodiment, ferulic acid and ferulic acid derivatives are removed from a biomass, including treating the biomass with an alkaline water-alcohol solution to form a liquid fraction; and separating/recovering the ferulic acid and ferulic acid derivatives.

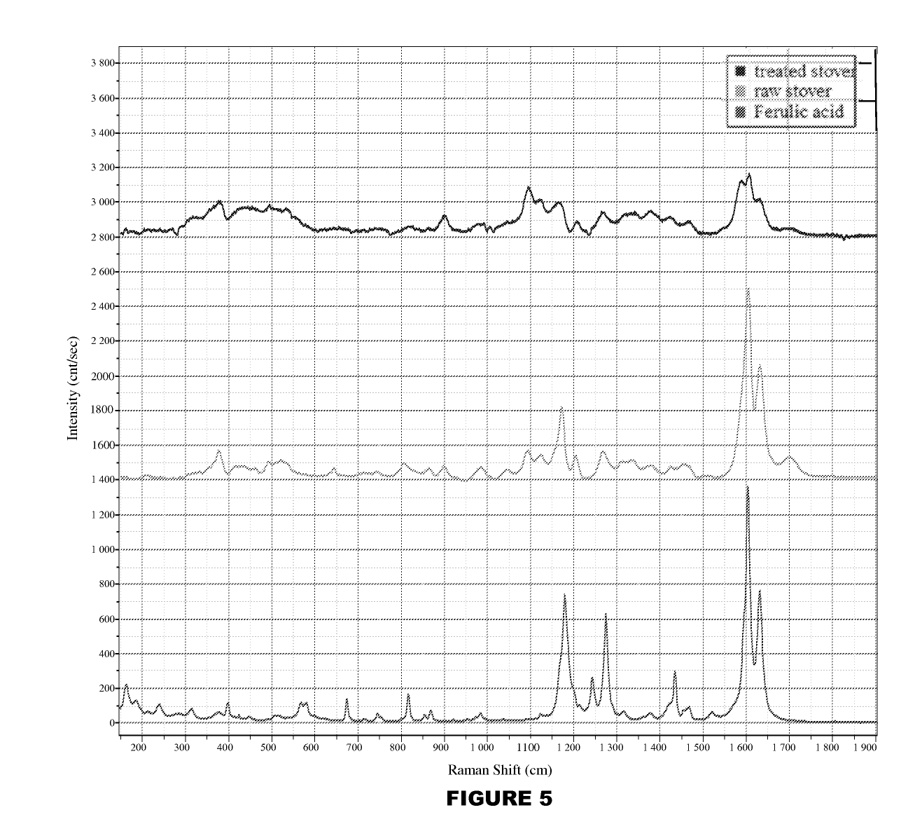

The removal of phytochemicals and at least a portion of the lignin in a biomass is presented in FIG. 5, which shows the Raman spectra of corn stover before and after it has been treated by the process embodying the principles described herein. Comparison of the spectrum of the treated stover with that of the raw stover indicates significant removal of lignin and phytochemical structures and substructures from the treated stover. The removal of significant amounts of phytochemicals and lignin is reflected in the significant decline of the bands at 1600 cm⁻¹, 1630 cm⁻¹ and 1192 cm⁻¹, all of which are signature bands characteristic of some lignin monomeric entities (5). There remain some bands at frequencies higher than 1500 cm⁻¹ that are also characteristic of lignin because not all the lignin is likely removed, but clearly a significant amount is removed. Ferulic acid, together with dihydroferulic acid, is a component of lignocellulose, serving to crosslink the lignin and polysaccharides, thereby conferring rigidity to the cell walls. Ferulic acid is a hydroxycinnamic acid, a type of organic compound. It is an abundant phenolic phytochemical found in plant cell wall. Phytochemicals are a plant's way of protecting itself. Phytochemcials help shield tender buds and sprouts from predators, the elements, and pollution.

A liquid fraction from the processes described herein containing a lignin composition and phytochemicals is also provided in embodiments described herein. The process described herein extracts lignin and phytochemicals from biomass, e.g., grassy herbaceous plants, the extracted lignin being in a form closer to its native state than any known laboratory procedure; little or no degradation is expected. Simultaneously, the process enhances the accessibility of cell wall polysaccharides to hydrolases in a manner that avoids the formation of inhibitors of enzyme or yeast action. As to the latter, conversion rates of the order of 75% to 80% in 21 hours of enzyme action were observed on treated corn stover treated in accordance with embodiments described herein in contrast to a conversion of 20% observed for corn stover that has simply been knife milled to 6 mm.

Establishing the molarity of the alkali, e.g., NaOH or KOH, of the treatment solution is an iterative process. As a beginning point, the co-solvent ratio is fixed at a level that was found optimal in the finishing of cotton (6), which is reported to be 75% ethanol and 25% water. The molarity is then varied and the effectiveness of the treatment is assessed until an optimum molarity of the alkali, e.g., NaOH, in the co-solvents is identified.

Studies were first carried out on pure cellulose samples, and then applied to lignocellulosic samples. The effect of the solutions on Avicel, a microcrystalline cellulose prepared from northern softwood (American Viscose Company, Marcus Hook, Pa.) and pulped at 180° C., was compared with earlier observations on other celluloses. It was found that a molarity of NaOH solutions of greater than 1 M, and suitably between 1 M and 2.5 M worked well. Avicel was selected for the testing because it has become the standard substrate used in most published studies of bioconversion of cellulose. Avicel is a highly recalcitrant cellulose and representative of the effects of elevated temperature on pulp crystallinity. In additional Examples, kraft pulps derived from a toilet paper were used. The toilet paper was of the type designed for use in septic systems so that it did not contain wet strength additives. The paper was made up of approximately 65% eucalyptus and 35% northern softwood.

In general, the molarity (normality) of hydroxide (e.g., NaOH) in co-solvent is greater than 1 M, and suitably 1-2.5 M (1-2.5 N) which may be considered “concentrated alkali”, e.g., compared to alkali concentrations used in prior art processes. On a pH basis, the pH is suitably equal or greater than 14. Also, generally, the mild reaction conditions for the treatment of biomass include a temperature from about 0° C. to 90° C., ambient pressure and the hydroxide (OH⁻) concentration described above.

As to the co-solvent, a suitable ratio of co-solvents is 75% water-miscible solvent and 25% water or a 3:1 ratio. It is anticipated that other ratios may be suitable, however, in varying the ratio, it is important to avoid levels of ethanol that can result in precipitation of alkali, e.g., NaOH.

An embodiment also contemplated is a kit, the kit including an alkali in an alcohol/water co-solvent, cellulase enzymes, one or more flocculants, and instructions for delignifying and deaggregating the biomass to produce a liquid fraction containing a lignin composition and deaggregated cellulose, and instructions for hydrolyzing the deaggregated cellulose to produce a hydrolysis product.

It is further envisioned that a similar treatment may make the cellulose more accessible to homogeneous catalysts that may be used to transform the cellulosic feedstock into other forms. For example, the deaggregated cellulose as described herein could be more easily penetrated by the catalytic systems to reform it into hydrocarbons. Such process could make possible use of the vast amount of cellulosic resources as feedstocks for catalytic reformation to generate biofuels, such as diesel, fuel gases, such as hydrogen, and other high-value chemical types. Thus, in some embodiments, a method of producing cellulosic biofuels is provided. The method includes treating a cellulosic material with an alkali in an alcohol/water co-solvent system to yield a deaggregated cellulose; washing the deaggregated cellulose to remove the alkali; hydrolyzing the cellulose to glucose and cello-oligodextrins; and catalytically reforming the glucose and cello-oligodextrins into hydrocarbons.

As described in the Examples below, the methods and systems described herein also include methods of enhancing the susceptibility of a lignocellulose-containing biomass to hydrolysis, of reducing inhibition of saccharification of a cellulosic material by lignin or phytochemicals, and of solubilizing at least a portion of lignin as well as the phytochemicals in a lignocellulose-containing biomass. The methods include treating the cellulosic or lignocellulosic material or biomass with an alkali in a co-solvent to yield a treated or pretreated material. This treating step is suitably carried out under mild temperature and pressure conditions. The substrate or material to be treated is suitably dried and in a particulate form, e.g., the material may be milled, e.g., knife-milled.

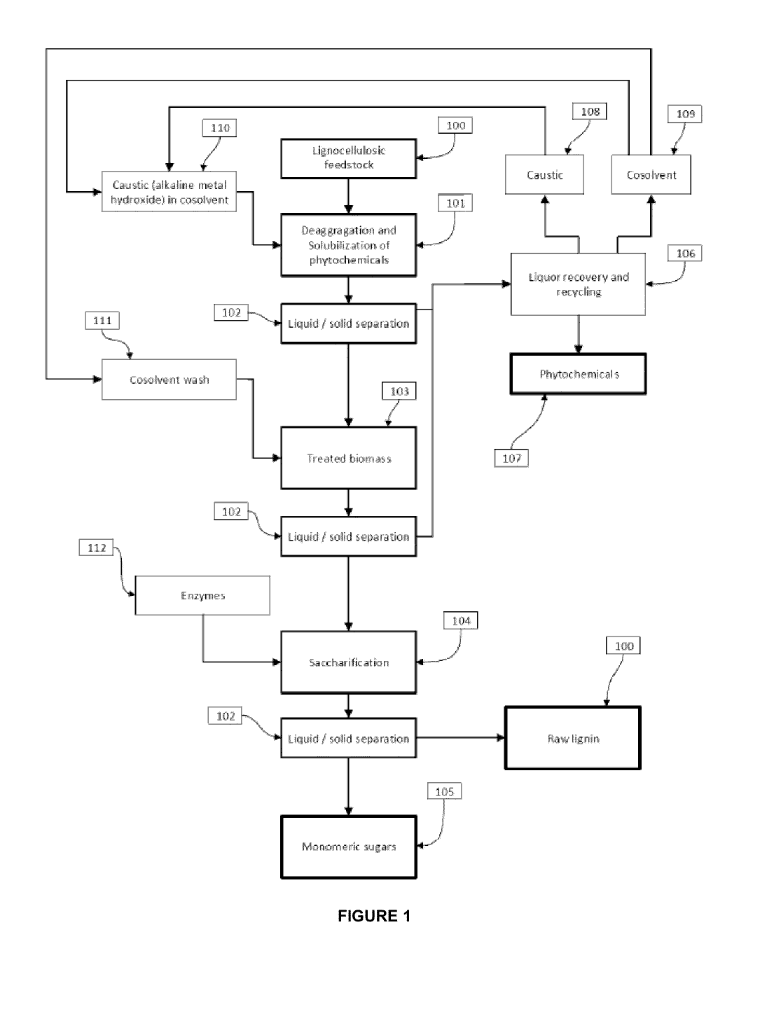

Reference is now made to FIG. 1, illustrating the general treatment process for embodiments described as well as further steps in the processing of biomass. The process begins at step 100 with a lignocellulosic source or biomass. In an illustrated embodiment, corn stover was used as a source of biomass at step 100.

Biomass is suitably in particulate form which may be effected by milling, crushing, grinding, shredding or chopping. Suitable particle sizes may be from 8-200 mesh.

The biomass is subjected to a pretreatment step 101 in accordance with embodiments described herein, e.g., a treatment solution of alkali in a co-solvent system 110 of water and a second solvent, such as an alcohol, e.g., ethanol, or another water-miscible solvent, to deaggregate the cellulose. At step 102, the reaction mixture is separated into a liquid fraction and an extracted and deaggregated biomass fraction that can be regarded as a bagasse 103. Removal of the liquid phase containing the major fraction of extracted biomass may suitably be, e.g., by centrifugation or filtration. The treated biomass or bagasse is washed with a washing co-solvent solution or mixture 111 to remove remaining components of the extractives and the alkali. The washing co-solvent or mixture is suitably an alcohol/water mixture with final wash with water. A repeat of step 102 follows the wash of the alkali and extractives from the biomass. At step 112, the treated biomass or bagasse in accordance with embodiments described herein may be hydrolyzed, for example, by treatment with hydrolytic enzymes 112 to form sugars. Another liquid solid separation step 102 can separate the aqueous solution of monosaccharides from residual lignin.

The liquid fraction separated after the first stage of pretreatment and the washes can be suitably concentrated for extraction of the phytochemicals and the low molecular weight lignins and lignans. The processes for further fractionation of the extractives are inherently species specific to the source or sources of biomass undergoing extraction and will depend on the relative amounts of phytochemicals, low molecular weight lignins and lignans and possibly small amounts of oligosaccharides.

The diversity of plant species as well as the diversity of structures of phytochemicals that occur between species and even among species is such that chemical analytical measures cannot provide a basis for comparison of the effectiveness of the extraction process. A simple measure of the effectiveness of the extraction processes was sought. One very suitable measure is the loss in oven dry weight of the biomass after treatment with the extracting mixture and washing to remove residues retained in the biomass after the first solid/liquid separation stage. For this purpose the combined weight loss after the first extraction and the following washes was measured.

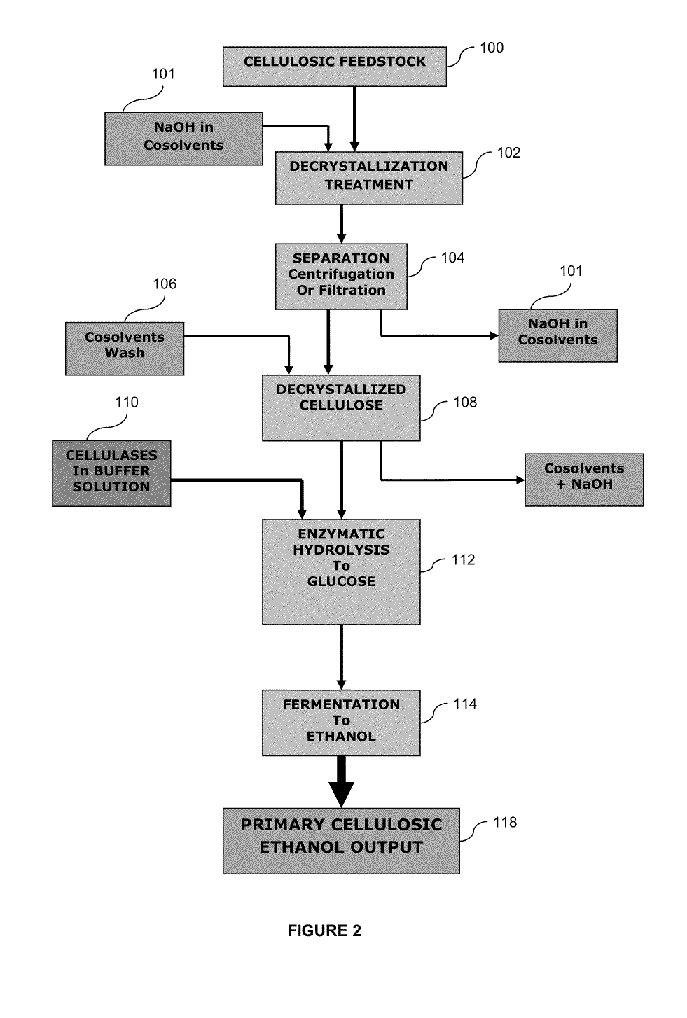

Reference is now made to FIG. 2 that illustrates the general treatment process for embodiments described with regard to cellulose as well as further steps in the processing of cellulosic feedstock to an alcohol, e.g., ethanol. The process begins at step 200 with a cellulosic source. In an illustrated embodiment, Avicel was used as a source of cellulose at step 200.

At step 202, the cellulosic material is subjected to a pretreatment step in accordance with embodiments described herein, e.g., a treatment solution of alkali in a co-solvent system 201 of water and a second solvent, such as an alcohol, e.g., ethanol, or another water-miscible solvent, to deaggregate the cellulose. At step 204, the reaction mixture is separated to yield the decrystallized cellulose 208 and remove the treatment solution 201. At step 206, the treated cellulose is washed with a washing co-solvent solution 207 to remove the alkali. The washing co-solvent is suitably an alcohol/water mixture with final washing with water. At step 212, the treated cellulose in accordance with embodiments described herein is hydrolyzed, for example, by treatment with cellulases 210, to form sugars. At step 214, the sugars, which include glucose and cello-oligodextrins, are suitably fermented, and a cellulosic alcohol 218 is recovered from the fermentation mix via distillation or other separatory method, e.g., membrane separation.

The effectiveness of the treatment solution is suitably measured by the onset of disruption of the Raman spectrum of cellulose, particularly in the low frequency region between 250 cm⁻¹ and 600 cm⁻¹ wherein the band at 378 cm⁻¹ is a very sensitive index of the degree of perturbation of the native lattice.

As to the washing solution 207, if methanol was used as the co-solvent with water, it has been found that the same ratio of methanol to water as in the treatment co-solvent system is suitable for washing NaOH, as the alkali, out of the cellulose. For the ethanol/water system, a suitable ratio was also the same as in the treatment co-solvent.

It was noted earlier that the work with methanol was based on using the same ratio of co-solvents as in the pretreatment and was used as the starting point for ethanol/water co-solvent. The effect of varying the initial co-solvent for the first wash was determined. From a process perspective, it is especially suitable if the co-solvent ratio in the washing mixture is higher in ethanol than that used for the pretreatment as that would reduce the cost of post treatment of the washing solution. However, it is again noted that it is necessary to ensure that the ethanol content of the initial wash is not high enough to cause precipitation of the alkali, e.g., NaOH.

After the first wash is completed, it is necessary to continue washing the cellulose substrate until a neutral pH is achieved. It was found in some cases that it was more effective to transition from the first wash to washes with co-solvents including higher levels of water, before eventually washing with water only.

An assay was developed for the transformations of the celluloses that can provide a measure of enhancement of enzyme action. In such assay, the pretreated and washed cellulose are incubated with representative cellulases from Aspergillus niger and Trichoderma reesi to assess the effect of the transformations on susceptibility to enzyme action. As noted earlier, the increased availability of celluloses to the hydrolytic enzymes should increase the rate of conversion to sugars by at least one order of magnitude or more.

The following Examples, which should not be construed by way of limiting the scope of the processes described herein, further explain embodiments of the principles described herein. Moreover, all experimental processes may be further optimized for efficiency and the process of scale up is expected to achieve greater extraction of phytochemicals and lignin, and greater enhancement of efficiency of conversion of cellulose to sugars.

### EXAMPLES

Experiments to demonstrate partial extraction of lignin and phytochemicals and reduction of the recalcitrance of cellulose were part of a broader program directed at deriving higher value from agricultural residues. It was carried out in three phases. The first focused on treatment of native celluloses to facilitate conversion to monosaccharides and assessed the effectiveness of this treatment by exposing the treated cellulose samples to hydrolytic enzymes and measuring its weight loss in comparison to controls consisting of untreated native cellulose from the same source. The second focused on the treatment of biomass or lignocellulosic feedstock to extract phytochemicals and simultaneously deaggregate the polysaccharides including cellulose in the cell walls of the feedstock. The third phase was focused on assessing the enhancement of digestibility of corn stover as a ruminant animal feed. The first stage is described in detail elsewhere (see, U.S. patent application Ser. No. 12/935,447). The examples presented herein are focused on the goal of extracting maximum value from the phytochemicals and related extractives and on enhancement of digestibility by ruminant animals (e.g., cattle, goats, sheep, yaks, deer, llamas, buffalo).

The samples of biomass chosen for examples were corn stover that had not been previously processed except to knife milling to 6 mm, and sugar cane bagasse that had not previously been processed except to extract liquid from it. The third example that is provided here primarily for reference purposes was based on a sample of Avicel PH1, which has been used as a standard in the inventor's laboratory since the 1970s and was supplied by the American Viscose Company (Marcus Hook, Pa.). It is microcrystalline cellulose usually manufactured by acid hydrolysis of a high purity dissolving grade northern softwood pulp followed by mechanical disintegration of the pulp fibers and spray drying of the resulting dispersion of fiber fragments. This type of cellulose was chosen because Avicel has become a standard substrate in studies of enzymatic hydrolysis of cellulose and is representative of the most recalcitrant pulp-derived celluloses. The fourth example was based on corn stover that was used for in vitro rumen digestibility tests. The final two examples were for corn stover and wheat straw used for in situ rumen digestibility tests.

In the examples based on corn stover and sugar cane bagasse as feedstock enzymes provided from commercial suppliers Novozymes and Genencor were used. The enzymes used in the assessments of Avicel were a cellulase from the fungus Trichoderma reesi purchased from Worthington and a glucosidase derived from almonds available from Sigma Aldrich.

The digestibility tests were carried out by the Rock River Laboratory, in Watertown, Wis., a certified forage animal nutrition and soil testing laboratory in accordance with established procedures.

### Example 1

### Treatment of Dried, Knife-Milled Corn Stover

The corn stover used in this experiment was knife milled with a 6 mm screen size. The moisture content of the material was determined by microwave balance to be approximately 4.35%.

Two samples were weighed out and marked as follows:

| | |
|---|---|
| 2.014 g | X—experimental sample |
| 2.022 g | C—control sample |

The solution prepared for treatment of the corn stover consisted of a 1.5 N solution of potassium hydroxide (KOH) in a mixture of ethanol (CH₃CH₂OH) and water that was 75% ethanol by volume. To prepare the treatment solution, one mixes the ethanol and water, and then dissolves 8.42 g of KOH per 100 mL of the solvent mixture.

The treatment procedure was as follows: Both samples of stover were placed in 50 mL centrifuge tubes. The control was filled with 0.05N ammonium acetate buffer with a pH of 5.01 and set aside.

The experimental sample had 45 mL of KOH treatment solution added. It was shaken for 5 minutes, then centrifuged and decanted over filter paper. The sample was then refilled with the cosolvent mixture (75% ethanol, 25% water). The sample was then shaken for 5 minutes to allow diffusion of the KOH out of the cellulose.

The solvent was then centrifuged, decanted over filter paper and the process repeated two times. After decanting the solvent the last time, the sample was washed with water, decanted, and refilled with water. Using a pH meter, 85% phosphoric acid was added gradually to the sample until the pH of the fluid was 5.23

Both X and C received 0.12 ml of Novozymes' Cellic C-Tec 1 enzyme. Both samples were placed in the incubator at 600 rpm and 50° C. for 21 hours and 40 minutes. Each sample was centrifuged and decanted onto a tared fiber glass filter and dried in the microwave balance.

Results:

The weights after exposure to the enzyme mixture at 50° C. are given below in Table 1.

TABLE 1

| Sample | Initial Weight | Est Dry Wt | Fin Wt |
|---|---|---|---|
| X | 2.014 g | 1.926 g | 0.322 g |
| C | 2.022 g | 1.944 g | 1.549 g |

Previous experiments have shown that the treatment procedure results in removal of approximately 27% of the dry weight biomass, for which adjusted percentages are shown below in Table 2.

TABLE 2

| Sample | Est Dry Weight | Final Weight | Δ | % |
|---|---|---|---|---|
| X | 1.41 g | 0.322 g | 1.088 g | 77.1% |
| C | 1.944 g | 1.549 g | 0.395 g | 20.3% |

where Δ represents the amount of solid digested during incubation. Thus, without use of elevated temperature, the loss in weight of the experimental sample is significantly higher, even when corrected for the mass removed during the application of the treatment procedure.

In the experiment wherein it was shown that 27% of the sample was removed during the treatment, the biomass matter extracted in the treatment and the wash was isolated. In the first step toward isolating this fraction the solids were precipitated by neutralization of the solutions. The precipitated matter was then placed in a dialysis instrument with membranes permeable with a cut off molecular weight (COW) of 1000. That is the membranes are permeable to any species with a molecular weight less than 1000. It was observed that all of the solvated matter was removed indicating that the fraction solubilized during the treatment, including phytochemicals and low molecular weight lignins and lignans consisted of substances that had molecular weights less than 1000.

These results indicate that a portion of the constituents of corn stover were solubilized during the alkali/co-solvent treatment. In a similar experiment, the first water wash was neutralized with acetic acid, resulting in precipitation of some solubilized material. Raman spectroscopy showed the precipitated material to be low molecular weight lignin and related phytochemicals.

These results indicate the inhibition of the saccharification of the corn stover by lignin and inhibitory phytochemicals had been significantly reduced, and that the method in accordance with the embodiments described herein is advantageous in overcoming both the recalcitrance of cellulose to hydrolysis and the inhibition of enzyme action by phytochemicals. It is well-known that some of the phytochemicals in plants are part of evolutionary adaptation to protect plants from pathogens, pests and predation by herbivores.

### Example 2

### Treatment of Dried Milled Sugar Cane Bagasse

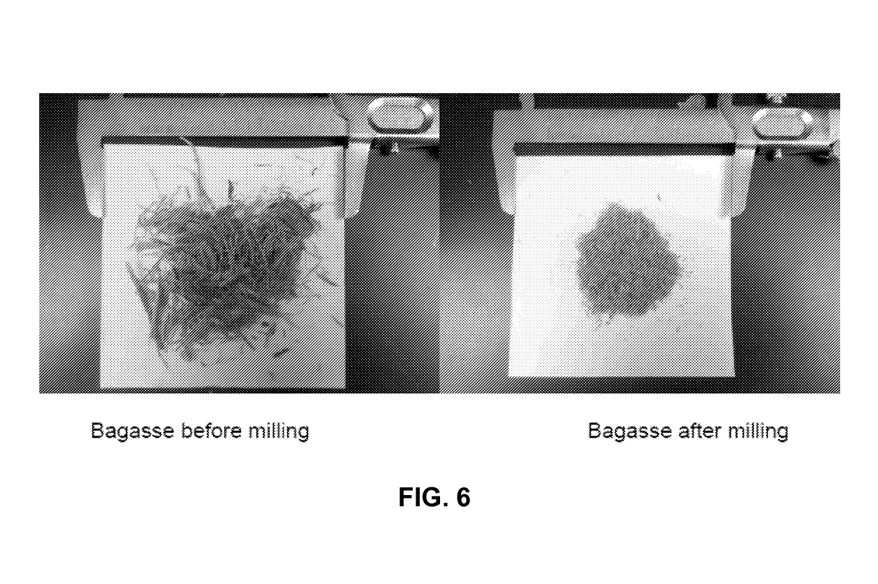

The material used in this experiment was sugar cane bagasse milled in a Waring blender. See FIG. 6

Two samples were used to determine weight loss resulting from the CSI treatment process.

Samples were weighed out as follows:
A—2.211 g—used to determine weight loss from CSI treatment
B—2.239 g—used to determine weight loss from CSI treatment
C—2.222 g—subjected to CSI process and then enzymatic hydrolysis
D—2.230 g—subjected to CSI process and then enzymatic hydrolysis
E—1.779 g—1.601 g est dry wt—untreated bagasse, used as control
F—1.770 g—1.6 g est dry wt—untreated bagasse, used as control

The raw bagasse was determined to have a moisture content of approximately 10%. A, B, C, and D were placed in 50 mL centrifuge tubes, which were then filled with a solution of 1.5 molar sodium hydroxide in a co-solvent mixture of 75% ethanol and 25% water. These samples were then placed in a Vortemp 1550 incubator and shaken for 5 minutes at room temperature (22° C.), after which they were centrifuged and the treatment solution was decanted.

The tubes containing A, B, C and D were then refilled with a co-solvent mixture of 75% ethanol and 25% water and shaken in the incubator for 5 minutes. The tubes were then centrifuged and decanted. Co-solvent washing was repeated 2 more times for a total of 3 co-solvent washes after the treatment solution.

The tubes containing A, B, C and D were then filled with water and shaken, centrifuged and decanted a total of 3 times. After this, samples C and D had acetic acid dropped in until the pH reached 5.22 and 5.15 respectively.

Samples A and B were centrifuged and decanted. The solids were dried in a microwave balance to determine how much solid material had been removed from each sample as a result of applying the treatment protocol described herein. The results are shown below in Table A:

TABLE A

| | Initial | | | | | |
|---|---|---|---|---|---|---|
| Sample | weight | Est. dry weight | Final weight | | Δ (dry basis) | % lost |
| A | 2.211 g | 1.989 | 1.579 | g | 0.41 g | 20.61% |
| B | 2.239 g | 2.015 | 1.625 | | 0.39 g | 19.35% |

The average loss between A and B is 19.98 and this is used to adjust the starting dry weight of treated samples C and D in the tables given below when calculating percentage enzyme loading and conversion percentage.

Samples E and F were placed in a 50 mL centrifuge tube, which was then filled with a 0.05 M ammonium acetate buffer with a pH of 5.08. Samples C, D, E, and F each received 0.048 mL doses (3% of the starting dry weight of the biomass) of Novozymes Cellic C-Tec 2 enzyme, and placed in the Vortemp incubator. These four samples were then incubated for 20 hours at 50 C@800 rpm.

At the end of the incubation period, C, D, E, and F were centrifuged and the supernatant decanted and set aside. The remaining solids were placed in a microwave balance and dried to determine dry weight of the remaining solids from each sample. The results for the experimental samples are shown in Table B, and the control samples in Table C:

TABLE B
(experimental samples)

| Sam- | Init. | Est. dry | Post- | Final | | | % con- |
|---|---|---|---|---|---|---|---|
| ple | weight | weight | trtmt | weight | pH | Δ | version |
| C | 2.222 g | 2.000 g | 1.600 g | 0.771 g | 5.22 | −0.829 g | 51.81% |
| D | 2.230 g | 2.007 g | 1.606 g | 0.780 g | 5.13 | −0.826 g | 51.43% |

TABLE C
(control samples)

| Sam- | Init. | Est. dry | Final | | | % con- |
|---|---|---|---|---|---|---|
| ple | weight | weight | weight | pH | Δ | version |
| E | 1.779 g | 1.601 g | 1.486 g | 5.08 | −0.115 g | 7.18% |
| F | 1.770 g | 1.6 g | 1.468 g | 5.08 | −0.132 g | 8.25% |

It is to be noted that the weight loss associated with extractives was approximately 20% in sugar cane bagasse, and that is calculated on a dry basis.

In addition to Examples 1 and 2, the process of extraction was applied in a preliminary manner that is, for short durations of at most 5 minutes each, to both Wiley-milled southern pine chips and to Wiley-milled birch chips. In both instances, significant weight losses on an oven dried basis were also observed.

### Example 3

### Decrystallization

A solution prepared for treatment of the Avicel was a 1.5 N (1.5 M) solution of sodium hydroxide (NaOH) in a mixture of ethanol (CH₃CH₂OH) and water that was 75% ethanol by volume. To prepare the treatment solution, ethanol and water were mixed, and then 6 g of NaOH was dissolved per 100 mL of the solvent mixture.

The treatment procedure was as follows: 1 g of Avicel was placed in a 300 mL beaker. To this, 50 mL of the treatment solution were added. The Avicel was allowed to sit in the treatment solution for 15 minutes. Thereafter, the solution was decanted and replaced with 100 mL of the solvent mixture (75% ethanol, 25% water). This solution was allowed to sit for a few minutes to allow diffusion of the NaOH out of the cellulose.

The solvent was then decanted and the process repeated two times whereupon the pH was approximately 8. After decanting the solvent the last time, a solution of 0.05 M ammonium acetate buffer at a pH of 5 was added; the pH was 5.4 after the rinse in buffer. The buffer solution was decanted, and 30 mL of buffer added again; the pH was then determined to be 5.0.

The dispersion of cellulose in 30 mL of buffer was transferred to a 50 mL polypropylene centrifuge tube and buffer added to the 40 mL level. Hydrolytic enzymes were added to the tube. These enzymes were 0.2 g cellulase (108 μ/mg) and 0.1 g β-glucosidase (6 μ/mg).

A control sample of 1 g of untreated Avicel was also placed in a 50 mL polypropylene centrifuge tube, and 40 mL of buffer added to it, followed by addition of the same amounts of enzymes as the test sample.

The two centrifuge tubes were then tightly closed with their covers, and inserted in a Vortemp 1550 shaking incubator. The contents of the tubes were incubated at 45° C. and agitated at a speed of 900 rpm. It was found necessary to agitate at 900 rpm to keep the cellulose microcrystalline particles adequately dispersed.

For a first experiment, the incubation was for 41 hrs, and for a second, the incubation was for 13 hrs.

After the incubation, the two dispersions were each divided into 8 portions in 15 mL centrifuge tubes. The tubes were inserted in a centrifuge and spun for 2 minutes at 3800 rpm. The buffer-enzyme liquid was decanted from each tube and replaced with 95% ethanol, re-dispersed and spun again; this was done twice for each of the samples. The last ethanol decanted was replaced with acetone followed by dispersion in the acetone.

The acetone dispersions were then, in turn, poured into tared crucibles with sintered glass bottom filters; the crucible filters were mounted on a vacuum flask with full vacuum applied during the filtration. The crucibles were then transferred to a vacuum oven with full vacuum applied, heated to 105° C., and held at that temperature under vacuum overnight.

The samples were then weighed on an analytical balance, and the weight loss taken as a measure of the conversion of cellulose to glucose and soluble oligomers.

Results:

As noted above, the initial weights of the test and control samples were 1 g each. The weights after exposure to the enzyme mixture at 45° C. are given below in Table 1.

TABLE 1

| Incumbation time | Control | Pretreated | Δ |
|---|---|---|---|
| 13 hrs | 0.535 g | 0.408 g | 0.127 g |
| 41 hrs | 0.251 g | 0.189 g | 0.062 g |

where Δ represents the difference in weight loss between the control and pretreated samples. Thus, in both instances the loss in weight of the sample treated as described herein was significantly greater than that of the control sample.

The results demonstrated that the loss in weight for both samples during the first 13 hr exposure was significantly higher than the loss during the further exposure for an additional 28 hrs. This is typical of the biphasic nature of enzyme action on celluloses where the rate of conversion to glucose or soluble oligomers proceeds rapidly at first but then levels off to a much slower rate. The results of these experiments demonstrate that the decrystallization treatment described herein increases the disorder in cellulose substrates, and makes them more susceptible to enzymatic hydrolysis by cellulases.

It should be noted that the 1.5 M (or 1.5 N) solution of NaOH in the solvent mixture was selected because the Avicel microcrystalline cellulose was derived from a dissolving pulp. Had microcrystalline cellulose made from cotton linters been used, it would have been necessary to use a 2 M (or 2 N) solution of NaOH in the solvent. Conversely, if the cellulose had been isolated from a herbaceous plant at a temperature much closer to ambient temperature, a 1 M (or 1 N) solution may have been adequate. This variability in the normality required for the pretreatment of cellulose reflects the great diversity in the level of aggregation of celluloses from different sources and with different histories into semicrystalline domains.

### Example 4

### In Vitro Digestibility of Treated Corn Stover

Two 50 g samples of corn stover that had not been previously processed except to knife milling to 6 mm were used to assess Enhancement of digestibility. One, identified as “untreated” was used as control. The test sample was treated with a 1.5 M solution of NaOH in a cosolvent consisting of 75% ethanol and 24% water by volume. The treatment was carried out for 10 minutes with constant agitation. The NaOH solution in the cosolvent was then drained. This was followed by washing the treated corn stover in cosolvent for 30 minutes with constant agitation. The dispersion of corn stover in the cosolvent wash was then drained on a large Buchner funnel mounted on a vacuum flask. Upon application of vacuum, the cosolvent was separated from the corn stover, which remained on the Buchner funnel. The corn stover was then washed multiple times with water until the pH of the wash water was about 9. The corn stover was then removed and allowed to air dry; it was identified as the “treated” sample.

The control and treated samples were submitted to Rock River Laboratory, in Watertown, Wis. for in vitro evaluation of change in digestibility. This test is carried out under anaerobic conditions in special flasks. After appropriate preparation of the samples, a buffer is added and the dispersion is inoculated with a fluid taken from the rumen of a lactating cow. The fluid contains the variety of microorganisms that occur in the rumen and contribute significantly to digestion of forage.

The two key indices of digestibility usually reported are dry matter disappearance (DMD) and neutral detergent fiber digestibility (NDFD). These are usually reported for multiple periods of digestion for each sample. As reported by Rock River Laboratory the results for the samples described above were:

| | |
|---|---|
| Untreated | Treated |

| Time | DMD | NDFD | DMD | NDFD |
|---|---|---|---|---|
| 7 hr | 26.10% | 0% | 35.51% | 10.6% |
| 24 hr | 48.21% | 28.86% | 75.33% | 66.63% |
| 120 hr | 74.46% | 64.91% | 89.48% | 92.22% |

It is clear that both DMD and NDFD are increased significantly as a result of the treatment. It is to be noted that the value at 24 hours, which is the approximate time when the forage leaves into the lower intestinal tract of the animal, the DMD is increased by over 50% while the NDFD is more than doubled. While DMD is a measure of all matter solubilized in the process, NDFD is regarded as a measure of available energy in the digested matter.

### Example 5

### In Situ Digestibility of Corn Stover

The corn stover used for this test was similar to that used in Example 4 except that the particle reduction was done by grinding and the average particle size was of the order of 5 mm. The treatment was identical to that used in Example 4. A control sample identified as “untreated” and the experimental, prepared according to the process described in Example 4 was identified as “treated”. The samples were sent to the Rock River Laboratory for in situ tests of digestibility. The in situ tests differ from the in vitro test in that the samples after appropriate preparative procedures are placed in small polyester bags with perforation of the order of 50 to 60 mm in size for placement directly in the rumen of lactating cannulated cows. The samples are left in the cow's rumen for varying periods, then removed and evaluated in the same manner as samples that have been tested in vitro. In the procedure used by Rock River Laboratory, samples are placed in three different cows to insure adequate replication. After removal, the samples from the three cows are combined and homogenized prior to the evaluation. The results are also reported in terms of DMD and NDFD. The results in this example were as follows:

| | |
|---|---|
| Untreated | Treated |

| Time | DMD | NDFD | DMD | NDFD |
|---|---|---|---|---|
| 8 hr | 16.01% | 7.00% | 16.62% | 17.09% |
| 24 hr | 34.63% | 27.17% | 52.42% | 52.99% |
| 80 hr | 52.96% | 49.30% | 86.08% | 87.33% |

Here again it is clear that the treated samples were much more easily digested with the NDFD after both 24 and 80 hours increased by approximately 80%.

### Example 6

### In Situ Digestibility of Wheat Straw

The procedures for this example were identical to those for Example 5 except that the agricultural residue used as wheat straw. Here again the control sample was identified as “untreated” and the sample processed as in Example 5 was identified as “treated”. The results for wheat straw were:

| | |
|---|---|
| Untreated | Treated |

| Time | DMD | NDFD | DMD | NDFD |
|---|---|---|---|---|
| 8 hr | 9.40% | 5.11% | 12.67% | 11.02% |
| 24 hr | 27.35% | 25.56% | 37.38% | 38.70% |
| 80 hr | 46.59% | 44.05% | 74.65% | 74.84% |

In the case of wheat straw, which differs somewhat in patterns of lignification from corn stover, the increased digestibility is still significant though it may not seem as dramatic as in the case of corn stove shown in Example 5.

The foregoing descriptions are considered as illustrative only of the principles of the embodiments described herein. Further, since numerous modifications and changes may readily occur to those skilled in the art, it is not desired to limit the embodiments to the exact construction and operation shown and described, and accordingly, all suitable modifications and equivalents are considered to fall within the scope of the embodiments. Various features and advantages of the embodiments and processes described herein are set forth in the following claims.

All publications, patents and patent applications referenced in this specification are indicative of the level of ordinary skill in the art to which this application pertains. All publications, patents and patent applications are herein expressly incorporated by reference to the same extent as if each individual publication or patent application was specifically and individually indicated by reference. In case of conflict between the present disclosure and the incorporated patents, publications and references, the present disclosure should control.

### REFERENCES

1. B. L. Browning, in “Methods of Wood Chemistry”, Interscience, New York, 1967, p. 75.
2. F. S. Nakayama et al., Industrial Crops and Products, 2001, 14, 105-111.
3. J. D. Bultman et al., Bioresource Technology, 1991, 35, 1997-2001.
4. European Patent Application #EP 2274433 A1
5. U. P. Agarwal and R. H. Atalla, “Vibrational Spectroscopy”, pp. 103-136, in Lignins and Lignans, C. Heitner, D. R. Dimmel and J. A. Schmidt, Eds, CRC Press, Taylor & Francis Group, Boca Raton, Fla. (2010).
6. R. Jeffries and J. O. Warwicker, Textile Res, J., 39, 548 (1969)

1. A method of extracting phytochemicals from a biomass, comprising:
(a) contacting a biomass with a treatment solution to obtain a liquid fraction and a solid fraction, the treatment solution being an alkaline co-solvent;
(b) separating the liquid fraction from the solid fraction; and
(c) recovering at least one phytochemical from the liquid fraction,
wherein the solid fraction is optionally dried and used as an animal feed.

2. The method of claim 1, wherein recovering step (c) includes separating and purifying the phytochemicals.

3. The method of claim 2, wherein the phytochemical is ferulic acid and ferulic acid derivatives.

4. The method of claim 1, wherein the phytochemicals have a molecular weight of less than 1000.

5. The method of claim 1, wherein the co-solvent comprises an organic solvent and water.

6. The method of claim 5, wherein the organic solvent is an alcohol, a diol or a protic solvent.

7. The method of claim 1, wherein the alkaline co-solvent includes an alkaline or alkaline earth hydroxide.

8. The method of claim 7, wherein the alkaline hydroxide is sodium hydroxide or potassium hydroxide.

9. The method of claim 8, wherein the sodium hydroxide or potassium hydroxide has a concentration of between about 1 and 2.5 M.

10. The method of claim 6, wherein the alcohol to water ratio in the co-solvent is 3:1 by volume.

11. A simultaneous method of extracting phytochemicals and disrupting the molecular structure of a lignocellulosic biomass, comprising:
(a) contacting a biomass with a treatment solution to form a slurry, the treatment solution being an alkaline co-solvent,
(b) separating the slurry into a liquid fraction and a solid fraction,
(c) separating the liquid fraction from the solid fraction,
wherein the liquid fraction includes one or more phytochemicals and wherein the solid fraction is optionally dried and used as an animal feed.

12. The method of claim 11, wherein the phytochemicals include ferulic acid and ferulic acid derivatives.

13. The method of claim 11, wherein the alkaline co-solvent is an alkaline or alkaline earth hydroxide in an aqueous aliphatic alcohol solution.

14. The method of claim 11, wherein the liquid fraction further includes at least a portion of the lignin in the biomass.

15. The method of claim 11, further comprising washing the solid fraction with co-solvent, followed by water, and neutralizing the liquid in contact with the biomass to yield an at least partially deaggregated biomass.

16. A method of enhancing digestibility of agricultural/forestry residue, comprising removing at least a portion of the phytochemicals from the residue and deaggregating the cellulosic structure of the residue by contacting the residue with an alkaline co-solvent treatment to yield an animal feed with enhanced digestibility compared to an untreated residue.

17. The method claim 16, wherein the phytochemicals include at least a portion of ferulic acid and ferulic acid derivatives from the cell walls of the residue in an amount effective to enhance the digestibility of the residue.

18. The method of claim 16, further comprising removing at least a portion of lignin of the residue.

19. An animal feed product, comprising:
a plant material treated with an alkaline co-solvent solution to remove at least a portion of phytochemicals/extractives and a portion of lignin in the plant material.

20. A process for preparing an enhanced digestibility feed from an agricultural residue, the process comprising:
performing an extraction process on the residue using an alkaline co-solvent comprising water, alcohol and a base;
filtering the solution to produce an extract solution and a treated residue; and
collecting and optionally drying the treated residue to yield an enhanced digestibility animal feed.
